(19) United States
(12) Patent Application Publication
(10) Pub. No.: US 2008/0146316 A1
(43) Pub. Date: Jun. 19, 2008

(54) GAMING MACHINE WITH BONUS GAME

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORPORATION, Tokyo (JP)

(21) Appl. No.: 11/956,738

(22) Filed: Dec. 14, 2007

(30) Foreign Application Priority Data
Dec. 15, 2006 (JP) 2006-339040

(51) Int. Cl. G06F 17/00

(52) U.S. Cl. 463/20; 463/31; 273/138.1

(57) ABSTRACT

A gaming environment, in which a payout corresponding to a selection selected by a player is provide, is described. Especially a gaming environment, in which in the selection game which is used to determine the predetermined magnifications of the free game, the first selection image in which two selection buttons 201L and 201R are arranged is displayed on the liquid crystal panel 5B, different predetermined magnification is allocated to each of the selection button 201L and 201R respectively, and when the predetermined magnification allocated to the selected button 201 is larger, the game proceeds to the next selection image, and a chance to select an even larger predetermined magnification is provided to the player, however, when the predetermined magnification allocated to the selected button 201 is smaller, the predetermined magnification is determined as the predetermined magnification for the free game, is described.

### CROSS-REFERENCE TO RELATED APPLICATIONS

This application is based upon and claims a priority from the prior Japanese Patent Application No. 2006-339040 filed on Dec. 15, 2006, the entire contents of which are incorporated herein by reference.

### BACKGROUND

1. Field

The present invention relates to a gaming machine in which a bonus game is conducted.

2. Description of Related Art

In the game executed in the conventional slot machine, no matter the mechanical slot machine or the video slot machine, a plurality of reels with a plurality of symbols are used. The game is started based on the setting of a predetermined bet number by a player. When the setting of the bet number by the player is detected by the slot machine, the reels are rotated, the variable display of the symbols arranged on the reel is executed, and then the symbols which are determined based on the internal lottery are stopped and displayed. At that time, at least one line (pay line) which crosses any one of the symbols displayed on each reel is preset, and it is determined whether or not a winning combination is obtained, corresponding to a symbol combination stopped on the pay line. And as a result of the winning combination determination, when the symbol combination becomes the winning combination, a payout is provided according to the symbol combination determined as the winning combination and the bet number.

Here, in the slot machine which is usually arranged in a casino and the like, when the winning combination is determined in the base game, winning of a bonus game is also determined. For example, as a result of the base game, when the symbol combination which is stopped and displayed is a winning combination, the game state shifts from the base game to the bonus game. In the bonus game, the player does not need to set a new bet number, and in many cases a favorable game for the player is usually developed. Thereby, the bonus game different from the base game is conducted, so as to attract the interest of the player.

Although there exist various modes in the bonus games, a plurality of symbols are variably displayed and stopped in a typical bonus game mode, similar to the base game. In such bonus game mode, the bonus games are automatically repeated over a predetermined number of times with a predetermined magnification through which the payout is increased, without newly betting by the player.

### SUMMARY

In view of the foregoing, one or more aspects of the present invention relate to a gaming machine, a gaming method thereof, a game system, a computer readable medium having computer-executable instructions or the like that by adding visual effects on the stage screen displayed on the display, so as to provide a gaming machine and a play method with new entertainment character which is not included in the conventional techniques.

One or more of the above aspects of the invention is more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is an explanatory view showing characteristics of the gaming machine according to the embodiment.

FIG. 2 is a perspective view of the slot machine according to the embodiment.

FIG. 3 is a schematic view showing symbol columns described on each of reels.

FIG. 4 is a block diagram schematically showing an internal construction of entire gaming machine according to the embodiment.

FIG. 5 is a block diagram schematically showing the internal construction of a sub-control board of the gaming machine according to the embodiment.

FIG. 6 is a payout table showing the winning combinations and payout amounts thereof when the base game or the free game is conducted by using the reels.

FIG. 7 is an explanatory view showing an image example displayed on a liquid crystal panel.

FIG. 8 is an explanatory view showing the other image example displayed on the liquid crystal panel.

FIG. 9 is an explanatory view showing another image example displayed on the liquid crystal panel.

FIG. 10 is a flowchart of a main control program in the gaming machine according to the embodiment.

FIG. 11 is a flowchart of a main game process program in the gaming machine according to the embodiment.

FIG. 12 is a flowchart of a free game process program in the gaming machine according to the embodiment.

FIG. 13 is a flowchart of an selection game process program in the gaming machine according to the embodiment.

FIG. 14 is an explanatory view showing a correlation between a selection number of times of selection images and predetermined magnifications allocated to two selection buttons on the selection images.

### DETAILED DESCRIPTION

The various aspects summarized precedingly may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention is described in detail with reference to the drawings based on an embodiment embodying one or more aspects of the invention as a slot machine, a server, a game system. However, it is appreciated that one or more aspects of the present invention may be embodied in distributable (via CD and the like) or downloadable software games, console games, and the like. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a side of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

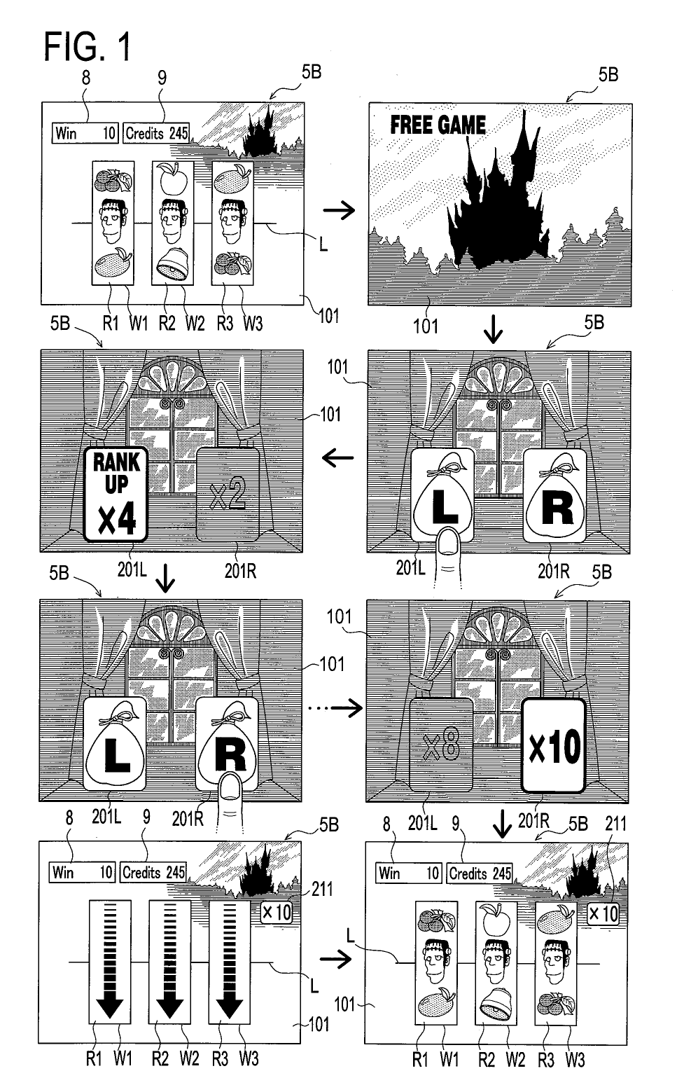

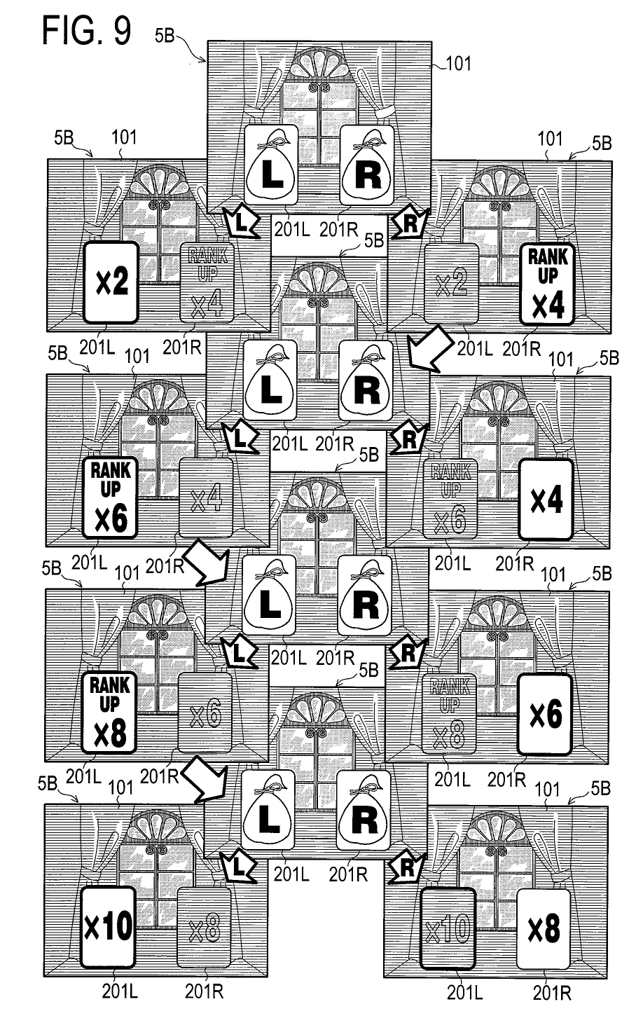

Hereinafter, the embodiment embodying the present invention is described with reference to the drawings. FIG. 1 is an explanatory view showing characteristics of a gaming machine according to the embodiment. When a liquid crystal panel 5B shown in FIG. 1 is specified, it is described by the No. of the row from the uppermost row of the figure. Regarding this, it is the same in the following FIG. 9.

The game conducted in the gaming machine of the embodiment is constructed from two game modes of a base game and a bonus game.

In the base game, as shown on the left side of the first row in FIG. 1, three symbols on each of three reels R1, R2, R3 are arranged through each of three display windows W1, W2, W3 which are made transparent, on the liquid crystal display panel 5B constructed from a well-known transparent liquid crystal display panel.

On the liquid crystal panel 5B, a pay line L, which crosses the three display windows W1, W2 and W3 horizontally, is displayed. The pay line L is used to define the combination of the symbols. Furthermore, a payout amount display portion 8 and a credit count display portion 9 are arranged on the liquid crystal panel 5B. And in front of the liquid crystal panel 5B, a touch panel 101 is arranged.

Also, each of various winning combinations is determined in advance based on the symbol combination of the symbols. And based on the rotation and stop of each reel R1, R2 and R3, three symbols are rearranged within each display window W1, W2 and W3. Here, when the symbol combination constructed from the three symbols rearranged on the pay line L corresponds to any of the winning combinations, the payout amount corresponding to the winning combination is displayed on the payout amount display portion 8. Thereby, a unit game is formed. The payout amount displayed on the payout amount display portion 8 is added to the credit count display portion 9 and is displayed, when the unit game is terminated. In other words, the base game is a so-called slot game.

When the symbol combination which is constructed from the three symbols rearranged on the pay line L, becomes a bonus game trigger, as shown on the left side of the first row in FIG. 1, a predetermined payout amount is displayed on the payout amount display portion 8, and the game shifts to a free game which is one kind of the bonus games. In the free game, the unit game in the base game is repeated over a predetermined number of times. Here, the payout amount obtained in each of the unit games is increased by multiplying the payout amount with a predetermined magnification, thereafter such payout amount is added and displayed in the payout amount display portion 8. And although the predetermined number of times (for example, 20 times) is predetermined, the predetermined magnification is determined right after the game shifts to the free game.

And when the game shifts to the free game, as shown on the right side of the first row in FIG. 1, the title image of the free game is displayed first on the liquid crystal panel 5B. At this time, the pay line L is erased from the liquid crystal panel 5B. Also the three display windows W1, W2 and W3 are turned to opaque, thereby each of the reels R1, R2 and R3 becomes invisible to the player.

Also, as a matter of convenience for description, on the liquid crystal panel 5B displayed in the right side of the first row in FIG. 1, the payout amount display portion 8 and the credit count display portion 9 are omitted. Regarding this, it is the same in the liquid crystal panel 5B shown on the second and the third rows in FIG. 1. And the above omission is also applied to the liquid crystal panel 5B shown in FIG. 9.

Furthermore, as shown in the second row and third row in FIG. 1, on the liquid crystal panel 5B, an selection game for determining the predetermined magnification of the free game is executed. In the selection game, as shown on the liquid crystal panel 5B displayed in the right side of the second row or the left side of the third row in FIG. 1, a selection image on which two selection buttons of 201L and 201R are arranged is displayed. And the selection image may be repeated to display at a maximum of four.

Here, to one of the two selection buttons of 201L and 201R in the first selection image, a predetermined magnification expressed by a mathematical formula of “×2” (abbreviated as “a predetermined magnification of “×2”” hereinafter) is allocated, to the other selection button a predetermined magnification expressed by a mathematical formula of “×4” (abbreviated as “a predetermined magnification of “×4”” hereinafter) is allocated. And to one of the two selection buttons of 201L and 201R in the second selection image, a predetermined magnification of “×4” is allocated, to the other selection button a predetermined magnification expressed by a mathematical formula of “×6” (abbreviated as “a predetermined magnification of “×6”” hereinafter) is allocated. Also, to one of the two selection buttons of 201L and 201R in the third selection image, a predetermined magnification of “×6” is allocated, to the other selection button a predetermined magnification expressed by a mathematical formula of “×8” (abbreviated as “a predetermined magnification of “×8”” hereinafter) is allocated. Furthermore, to one of the two selection buttons of 201L and 201R in the fourth selection image, a predetermined magnification of “×8” is allocated, to the other selection button a predetermined magnification expressed by a mathematical formula of “×10” (abbreviated as “a predetermined magnification of “×10”” hereinafter) is allocated. And to the two selection buttons of 201L and 201R in the first selection image to the third selection image, a message of “RANK UP” is added to the magnification with a larger value (see the left side of the second row in FIG. 1).

And when any of the two selection buttons of 201L and 201R in each selection image is selected by the player through the touch panel 101, for example, as shown on the liquid crystal panel 5B displayed in the right side of the second row or the left side of the third row in FIG. 1, the two selection buttons 201L and 201R are opened, and the mathematical formula of the predetermined magnification allocated to each selection button is displayed. At this time, the predetermined magnification allocated to the selection button 201 which is the selected object of the player (abbreviated as “selected button” hereinafter), is more clearly shown the liquid crystal panel 5B than the predetermined magnification allocated to the selection button 201 which is not the selected object of the player (abbreviated as “not selected button” hereinafter).

Furthermore, in the first selection image to the third selection image, when the predetermined magnification allocated to the selected button 201, is larger than that allocated to the not selected button 201 in the value, the game proceeds to the next selection image. However, when the predetermined magnification allocated to the selected button 201, is smaller than that allocated to the not selected button 201 in the value, the predetermined magnification allocated to the selected button is determined as the predetermined magnification for the free game, thereby the selection game is terminated without proceeding the game to the next selection image. Also, in the fourth selection image, without reference to the value of the predetermined magnification, the predetermined magnification allocated to the selected button is determined as the predetermined magnification for the free game, and the selection game is terminated.

And in the selection game shown in each liquid crystal panel 5B on the second row and the third row in FIG. 1, the game proceeds to the fourth selection image, it is determined that the mathematical formula of the predetermined magnification allocated to the selected button 201R is “×10”. And “×10” is determined as the predetermined magnification for the free game, and the selection game is terminated (as shown on the right side of the third row in FIG. 1). By the say, in the second row and the third row of FIG. 1, there are omitted the state in which two selection buttons 201L and 201R are opened in the second selection image, the state in which the third selection image is displayed, the state in which two selection buttons 201L and 201R are opened in the third selection image and the state in which the fourth selection image is displayed, on the liquid crystal display panel 5B.

On the liquid crystal panel 5B after the selection game is terminated, as shown on the right side of the fourth row in FIG. 1, the image returns to the display state just before shifting to the free game. However, at this time, a predetermined magnification display portion 211 is newly arranged, to display the predetermined magnification determined in the selection game. And as shown on the liquid crystal panel 5B displayed in the left side of the fourth row in FIG. 1, based on the starting of the rotation of each reel R1, R2 and R3, the first unit game comprising the free game is started.

Hereinafter, the embodiment embodying the present invention will be described in detail with reference to the drawings.

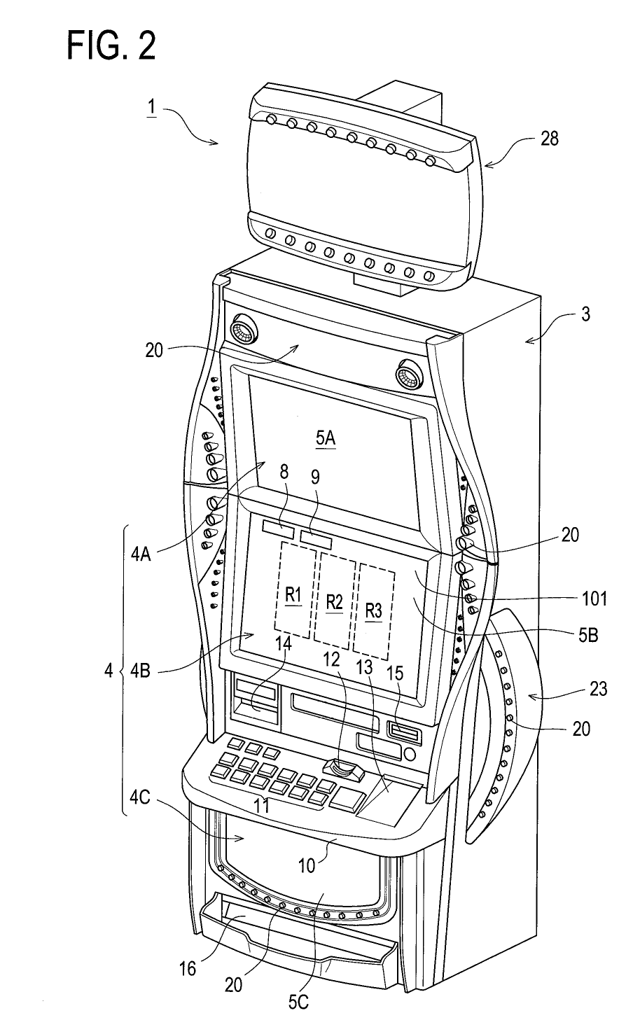

First, an outline construction of the gaming machine 1 according to the embodiment is described with reference to FIG. 2. FIG. 2 is perspective view of the gaming machine 1 according to the embodiment.

As shown in FIG. 2, the gaming machine 1 is an upright type slot machine arranged in the game arcade such as casino, in order to execute predetermined game modes, such slot machine includes a cabinet 3 in which electronic and mechanical components are installed. For example, as a display portion 4 to display information concerning the game, there are provided an upper display portion 4A, a middle variable display portion 4B and a lower display portion 4C. Each display portion 4A to 4C is mounted at the front of the oblong cabinet 3. The upper display portion 4A includes a liquid crystal panel 5A which is arranged above the middle variable display portion 4B. On the liquid crystal panel 5A, for example, the effect image, the introduction of the game content, and the rule explanation of the game are displayed. The lower display portion 4C is arranged below the middle variable display portion 4B, and includes a plastic panel 5C on which the images are printed, and the plastic panel 5C is lightened by the backlights.

The middle variable display portion 4B, which is used to display the execution state of the game, includes a transparent liquid crystal panel 5B which is fixed at the front door of the cabinet 3. Through the liquid crystal panel 5B, the symbols on each reel R1, R2 and R3 arranged inside the cabinet 3, may be visible by a player. In the middle variable display portion 4B, one pay line L horizontally crossing each of areas corresponding to the reels R1, R1, R3 is displayed on the liquid crystal display panel 5B. On the upper position of the middle variable display portion 4B, the payout amount display portion 8 and the credit count display portion 9 are arranged on the liquid crystal panel 5B. Also the upper portion of the middle variable display portion 4B, is related to the back side, thereby the player may play games in a cozy posture.

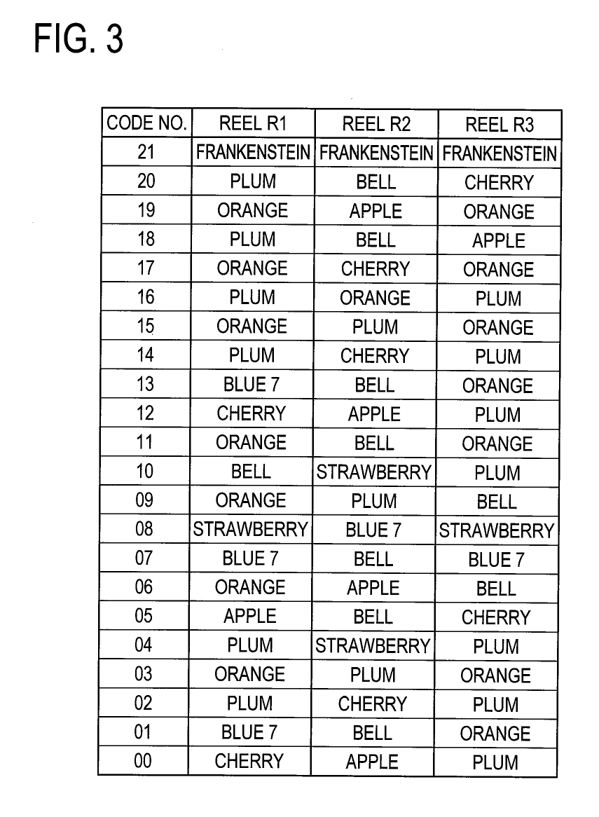

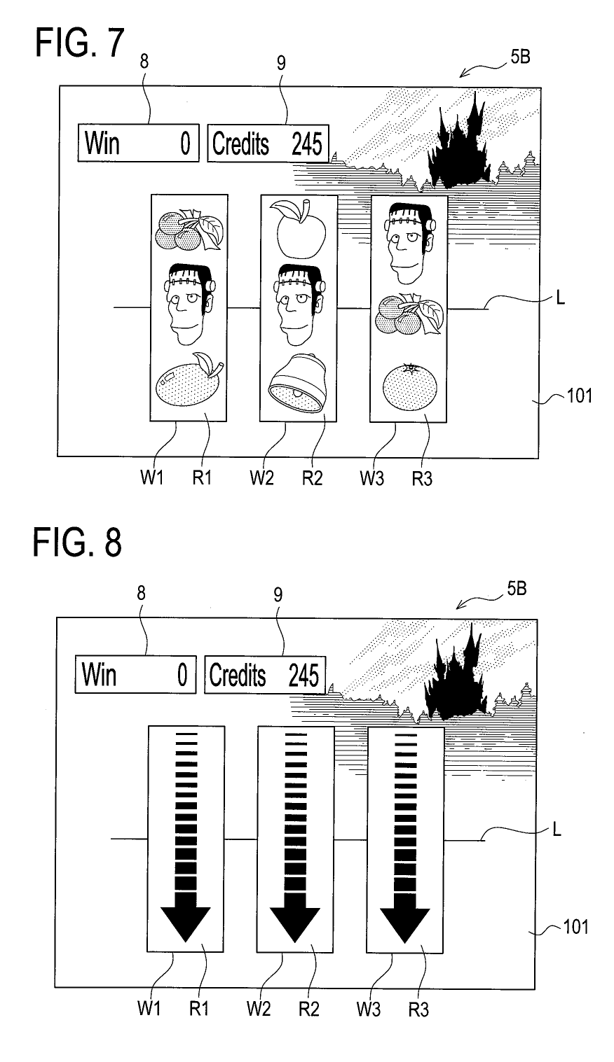

Here, the image of the base game displayed on the liquid crystal panel 5B will be explained. FIG. 7 and FIG. 8 are the figures showing the contents displayed on the liquid crystal panel 5B. On the liquid crystal panel 5B, in the base game, as shown in FIG. 7 and FIG. 8, each display window W1, W2 and W3 is changed to a transparent state, the symbols displayed on the reel strip of each reel R1, R2 and R3 may be visible by the player. FIG. 7 shows the arranged or rearranged state of the symbols which are displayed on the reel strip of each reel R1, R2 and R3, through each display window W1, W2 and W3 of the liquid crystal panel 5B. FIG. 8 shows the rotating state of the symbols which are displayed on the reel strip of each reel R1, R2 and R3, through each display window W1, W2 and W3. On the reel strip of each reel R1, R2 and R3, a symbol column constructed from twenty-two symbols is displayed respectively (see FIG. 3).

Also, in front of the liquid crystal panel 5B, the touch panel 101 is arranged, and a player may input his/her various instructions by operating the touch panel 101.

On the liquid crystal panel 5B, the payout amount display portion 8 and the credit count display portion 9 are arranged. On the payout amount display portion 8, the payout amount obtained in the base game (slot game) by a player is displayed. On the credit count display portion 9, the credit counts which is owned by the current player is displayed. Also, on the payout amount display portion 8, the payout amount obtained in the free game by the player is displayed.

Therefore, on the liquid crystal panel 5B in the base game, the three display windows W1, W2 and W3 are changed to a transparent state, three symbols which are displayed on the reel strip of each reel R1, R2 and R3 are visible through each display window W1, W2 and W3. On the liquid crystal panel 5B in the base game, as shown in FIG. 7 and FIG. 8, the pay line L crossing the three display windows W1, W2 and W3 horizontally is displayed. The pay line L is used to define the symbol combination.

And on the liquid crystal panel 5B right after the game shifts from the base game to the free game, the pay line L is erased, and the three display windows W1, W2 and W3 are turned to an opaque state, thereby the symbols displayed on the reel strip of each of the reels R1, R2 and R3 become invisible to the player. On the liquid crystal panel 5B, as shown on the right side of the first row in FIG. 1, the title image of the free game is displayed. And on the liquid crystal panel 5B, as shown on second row and the third row in FIG. 1, the selection game is executed.

Here, the images showing the selection game executed on the liquid crystal panel 5B right after the game shifts to the free game will be explained along with the game process. FIG. 9 is an explanatory view showing the content displayed on the liquid crystal panel 5B as one of the examples.

In the selection game executed on the liquid crystal panel 5B right after the game shifts to the free game, as shown in the liquid crystal panel 5B on the first image in the middle column in FIG. 9, the first selection image on which the two selection buttons 201L and 201R are arranged, is displayed. And in the first selection image, to one of the two selection buttons of 201L and 201R, a predetermined magnification of “×2” is allocated, and to the other selection button a predetermined magnification of “×4” is allocated. Furthermore, to the predetermined magnification of “×4” with a larger value, the message of “RANK UP” is added.

To explain this point in detail, for example, in the first selection image shown in the liquid crystal panel 5B on the first row in FIG. 9, to the selection button 201L, a predetermined magnification of “×2” is allocated. And to the other selection button 201R, a predetermined magnification of “×4” is allocated and also the message of “RANK UP” is added (see the both sides of the first row in FIG. 9).

And when any of the two selection buttons 201L and 201R is selected by a player through the touch panel 101, the two selection buttons 201L and 201R are opened, and the mathematical formula of the predetermined magnification allocated to each selection button is displayed. At this time, the predetermined magnification allocated to the selected button 201, is more clearly shown than the predetermined magnification allocated to the not selected button 201.

Furthermore, in the first selection image, when the predetermined magnification allocated to the selected button is larger than that allocated to the not selected button in the value, the game proceeds to the second selection image. However, when the predetermined magnification allocated to the selected button is smaller than that allocated to the not selected button in the value, the predetermined magnification allocated to the selected button is determined as the predetermined magnification for the free game, thereafter the selection game is terminated without proceeding the game to the next selection image.

To explain above point in detail, for example, in the first selection image shown in the liquid crystal panel 5B on the middle first column in FIG. 9, when the selection button 201L is selected by the player, as shown on the liquid crystal panel 5B displayed in the left side of the first row in FIG. 9, the two selection buttons 201L and 201R are opened, and the mathematical formula of the predetermined magnification allocated to each selection button is displayed. The predetermined magnification allocated to the not selected button 201R is “×4”. The magnification of “×4” and the message of “RANK UP” are blurred and displayed. The predetermined magnification allocated to the selected button 201L is “×2”. Since the predetermined magnification allocated to the selected button 201L (“×2”) is smaller than the predetermined magnification allocated to the not selected button 201R (“×4”) in the value, the predetermined magnification allocated to the selected button 201L which is “×2”, is determined as the predetermined magnification for the free game, thereafter the selection game is terminated without proceeding the game to the second selection image.

On the other hand, in the first selection image shown in the liquid crystal panel 5B in the first row in FIG. 9, when the selection button 201R is selected by the player, as shown on the liquid crystal panel 5B displayed in the right side of the first row in FIG. 9, the two selection buttons 201L and 201R are opened, and the mathematical formula of the predetermined magnification allocated to each selection button is displayed. The predetermined magnification allocated to the not selected button 201L is “×2”, and the magnification of “×2” is blurred and displayed. The predetermined magnification allocated to the selected button 201R is “×4”. Since the predetermined magnification allocated to the selected button 201R (“×4”) is larger than the predetermined magnification allocated to the not selected button 201L (“×2”) in the value, as shown in the liquid crystal panel 5B in the second image in the second column in FIG. 9, the second selection image in which two selection buttons 201L and 201R are arranged is displayed.

And in the second selection image, to one of the two selection buttons 201L and 201R, a predetermined magnification of “×4” is allocated, and to the other selection button, a predetermined magnification of “×6” is allocated. Furthermore, to the predetermined magnification of “×6” with a larger value, the message of “RANK UP” is added.

To explain above point in detail, for example, in the second selection image as shown in the liquid crystal panel 5B on the second image in the middle column in FIG. 9, to the selection button 201L, a predetermined magnification of “×6” is allocated, and the message of “RANK UP” is added, and to the selection button 201R, a predetermined magnification of “×4” is allocated (see the both sides of the second row in FIG. 9).

The following processes are the same as those in the case of the first selection image. In other words, in the second selection image, when any of the two selection buttons 201L and 201R is selected by the player through the touch panel 101, the two selection buttons 201L and 201R are opened, and the mathematical formula of the predetermined magnification allocated to each selection button respectively, is displayed. At this time, the predetermined magnification allocated to the selected button 201 is more clearly shown than that of the not selected button 201.

Furthermore, in the second selection image, when the predetermined magnification allocated to the selected button 201 is larger than that allocated to the not selected button 201 in the value, the game proceeds to the third selection image. However, when the predetermined magnification allocated to the selected button 201 is smaller than that allocated to the not selected button 201 in the value, the predetermined magnification allocated to the selected button 201 is determined as the predetermined magnification for the free game, thereafter the selection game is terminated without proceeding the game to the third selection image.

To explain above point in detail, for example, in the second selection image shown in the liquid crystal panel 5B on the second image in the middle column in FIG. 9, when the selection button 201R is selected by the player, as shown on the liquid crystal panel 5B displayed in the right side of the second row in FIG. 9, the two selection buttons 201L and 201R are opened, and the mathematical formula of the predetermined magnification allocated to each selection button is displayed. Here, the predetermined magnification allocated to the not selected button 201L is “×6”. The magnification of “×6” and the message of “RANK UP” are blurred and displayed. The predetermined magnification allocated to the selected button 201R is “×4”. Since the predetermined magnification allocated to the selected button 201R (“×4”) is smaller than that allocated to the not selected button 201L (“×6”) in the value, the predetermined magnification allocated to the selected button 201R which is “×4”, is determined as the predetermined magnification for the free game, thereafter the selection game is terminated without proceeding the game to the third selection image.

On the other hand, in the second selection image as shown in the liquid crystal panel 5B on the second image in the middle column in FIG. 9, when the selection button 201L is selected by the player, as shown on the liquid crystal panel 5B displayed in the left side of the second row in FIG. 9, the two selection buttons 201L and 201R are opened, and the mathematical formula of the predetermined magnification allocated to each selection button is displayed. The predetermined magnification allocated to the not selected button 201R is “×4”, and the magnification of “×4” is blurred and displayed. Since the predetermined magnification allocated to the selected button 201L (“×6”) is larger than that allocated to the not selected button 201R (“×4”) in the value, as shown in the liquid crystal panel 5B on the third image in the middle column in FIG. 9, the third selection image in which two selection buttons 201L and 201R are arranged, is displayed.

And in the third selection image, to one of the two selection buttons 201L and 201R, a predetermined magnification of “×6” is allocated, and to the other selection button a predetermined magnification of “×8” is allocated. Furthermore, to the predetermined magnification of “×8” which is a larger value, the message of “RANK UP” is added.

To explain above point in detail, for example, in the third selection image as shown in the liquid crystal panel 5B on the third image in the middle column in FIG. 9, to the selection button 201L, a predetermined magnification of “×8” is allocated, and the message of “RANK UP” is added, and to the selection button 201R, a predetermined magnification of “×6” is allocated (see the both sides of the third row in FIG. 9).

The following processes are the same as those in the case of the first and the second selection images. In other words, in the third selection image, when any of the two selection buttons 201L and 201R is selected by the player through the touch panel 101, the two selection buttons 201L and 201R are opened, and the mathematical formula of the predetermined magnification allocated to each selection button is displayed. At this time, the predetermined magnification allocated to the selected button 201 is more clearly shown than that of the not selected button 201. Furthermore, in the third selection image, when the predetermined magnification allocated to the selected button 201 is larger than that allocated to the not selected button 201 in the value, the game proceeds to the fourth selection image. However, when the predetermined magnification allocated to the selected button 201 is smaller than that allocated to the not selected button 201 in the value, the predetermined magnification allocated to the selected button 201 is determined as the predetermined magnification for the free game, thereafter the selection game is terminated without proceeding the game to the fourth selection image.

To explain above point in detail, for example, in the third selection image shown in the liquid crystal panel 5B on the third image in the middle column in FIG. 9, when the selection button 201R is selected by the player, as shown on the liquid crystal panel 5B displayed in the right side of the third row in FIG. 9, the two selection buttons 201L and 201R are opened, and the mathematical formula of the predetermined magnification allocated to each selection button is displayed. Here, the predetermined magnification allocated to the not selected button 201L is “×8”. The magnification of “×8” and the message of “RANK UP” are blurred and displayed. The predetermined magnification allocated to the selected button 201R is “×6”. Since the predetermined magnification allocated to the selected button 201R (“×6”) is smaller than that allocated to the not selected button 201L (“×8”) in the value, the predetermined magnification allocated to the selected button 201R which is “×6”, is determined as the predetermined magnification for the free game, thereafter the selection game is terminated without proceeding the game to the fourth selection image.

On the other hand, in the third selection image shown in the liquid crystal panel 5B on the third image in the middle column in FIG. 9, when the selection button 201L is selected by the player, as shown on the liquid crystal panel 5B displayed in the left side of the third row in FIG. 9, the two selection buttons 201L and 201R are opened, and the mathematical formula of the predetermined magnification allocated to each selection button is displayed. The predetermined magnification allocated to the not selected button 201R is “×6”, and the magnification of “×6” is blurred and displayed. The predetermined magnification allocated to the selected button 201L is “×8”. Since the predetermined magnification allocated to the selected button 201L (“×8”) is larger than that allocated to the not selected button 201R (“×6”) in the value, as shown in the liquid crystal panel 5B on the fourth image in the middle column in FIG. 9, the fourth selection image in which two selection buttons 201L and 201R are arranged, is displayed.

And in the fourth selection image, to one of the two selection buttons 201L and 201R, a predetermined magnification of “×8” is allocated, and to the other selection button, a predetermined magnification of “×10” is allocated. Furthermore, to the predetermined magnification of “×10” which is a larger value, the message of “RANK UP” is added.

To explain above point in detail, for example, in the fourth selection image as shown in the liquid crystal panel 5B on the fourth image in the middle column in FIG. 9, to the selection button 201L, a predetermined magnification of “×10” is allocated, and the message of “RANK UP” is added, and to the selection button 201R, a predetermined magnification of “×8” is allocated (see the both side of the fourth row in FIG. 9).

The following processes are the same as those in the cases of the first to the third selection images. In other words, in the fourth selection image, when any of the two selection buttons 201L and 201R is selected by the player through the touch panel 101, the two selection buttons 201L and 201R are opened, and the mathematical formula of the predetermined magnification allocated to each selection button is displayed. At this time, the predetermined magnification allocated to the selected button 201 is more clearly shown than that allocated to the not selected button 201.

In the fourth selection image, without reference to the value of the predetermined magnification, the predetermined magnification allocated to the selected button is determined as the predetermined magnification for the free game, and the selection game is terminated.

To explain above point in detail, for example, in the fourth selection image shown in the liquid crystal panel 5B on the fourth image in the middle column in FIG. 9, when the selection button 201R is selected by the player, as shown on the liquid crystal panel 5B displayed in the right side of the fourth row in FIG. 9, the two selection buttons 201L and 201R are opened, and the mathematical formula of the predetermined magnification allocated to each selection button is displayed. Here, the predetermined magnification allocated to the not selected button 201L is “×10”, and the magnification of “×10” is blurred and displayed. The predetermined magnification allocated to the selected button 201R is “×8”. The magnification of “×8” is determined as the predetermined magnification for the free game, the selection game is terminated.

On the other hand, in the fourth selection image shown in the liquid crystal panel 5B on the fourth image in the middle column in FIG. 9, when the selection button 201L is selected by the player, as shown on the liquid crystal panel 5B displayed in the left side of the fourth row in FIG. 9, the two selection buttons 201L and 201R are opened, and the mathematical formula of the predetermined magnification allocated to each selection button is displayed. The predetermined magnification allocated to the not selected button 201R is “×8”, and the magnification of “×8” is blurred and displayed. And the predetermined magnification allocated to the selected button 201L which is “×10”, is determined as the predetermined magnification for the free game, thereafter the selection game is terminated.

On the liquid crystal panel 5B after the selection game of the free game is terminated (see the right side of the fourth row in FIG. 1), the image returns to the display state just before shifting to the free game. The first unit game comprising the free game is started based on the starting of the rotation of each reel R1, R2 and R3 (see the left side of the fourth row in FIG. 1). At this time, the image of the free game displayed on the liquid crystal panel 5B, is the same as the image of the above base game, except that the predetermined magnification display portion 211 to display the predetermined magnification determined in the selection game is arranged (see the fourth row in FIG. 1).

Returning to FIG. 2, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a Cash Out button, are arranged as the operation portion to execute the game. On the operation table 10, a coin insertion slot 12 and a bill insertion portion 13 are arranged. Also between the operation table 10 and the middle variable display portion 4B, a ticket printer 14 and a card reader 15 are arranged. At the lowest position of the cabinet 3, a coin tray 16 is also arranged.

In the gaming machine 1 of the embodiment, the gaming medium may be coin, bill, or electronic value (credit). Here, the gaming medium may be others as well, such as medal, token, electronic money, or ticket.

On the cabinet 3 of the gaming machine 1, light emitting portions 20 are arranged around the game area including the upper display portion 4A, the middle variable display portion 4B, the lower display portion 4C and the operation table 10.

The gaming machine 1 also includes a topper effect device 28 which is installed on the cabinet 3. The topper effect device 28 is shaped in a rectangular board shaped, and is arranged almost parallel to the liquid crystal panel 5A of the upper display portion 4A.

Next, the symbols displayed on the reel strip of each reel R1, R2 and R3 will be explained with reference to FIG. 3. These symbols are scrolled and rearranged through each display window W1, W2 and W3 on the liquid crystal panel 5B during the base game and the free game. FIG. 3 is a schematic view schematically showing symbol columns displayed on the reel strip of each reel R1, R2 and R3.

On the reel strip of each reel R1, R2 and R3, twenty-two symbols are arranged respectively. Each symbol column is constructed from the symbols including “FRANKENSTEIN”, “Blue 7”, “BELL”, “APPLE”, “CHERRY”, “STRAWBERRY”, “PLUM” and “ORANGE”. And the symbols of the predetermined types are arranged in a predetermined sequence.

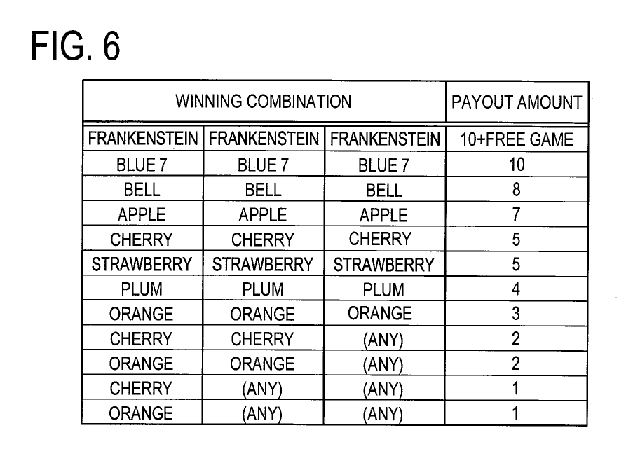

Here, when three symbols of “Blue 7”, “BELL”, “APPLE”, “CHERRY”, “STRAWBERRY”, “PLUM” and “ORANGE” are rearranged on the pay line L of the liquid crystal panel 5B, a predetermined payout amount is provided to the player (see FIG. 6). Also, regarding the symbols of “CHERRY” and “ORANGE”, even when one or two “CHERRY” or “ORANGE” is/are rearranged on the pay line L of the liquid crystal panel 5B, a predetermined payout amount corresponding to the number of the symbols is provided to the player (see FIG. 6).

When three symbols of “FRANKENSTEIN” are rearranged on the pay line L of the liquid crystal panel 5B, a predetermined payout amount is provided to the player, and also the game shifts from the base game to the free game.

To each symbol consisting each symbol column shown in FIG. 3, a symbol number is allocated from top to down in sequence.

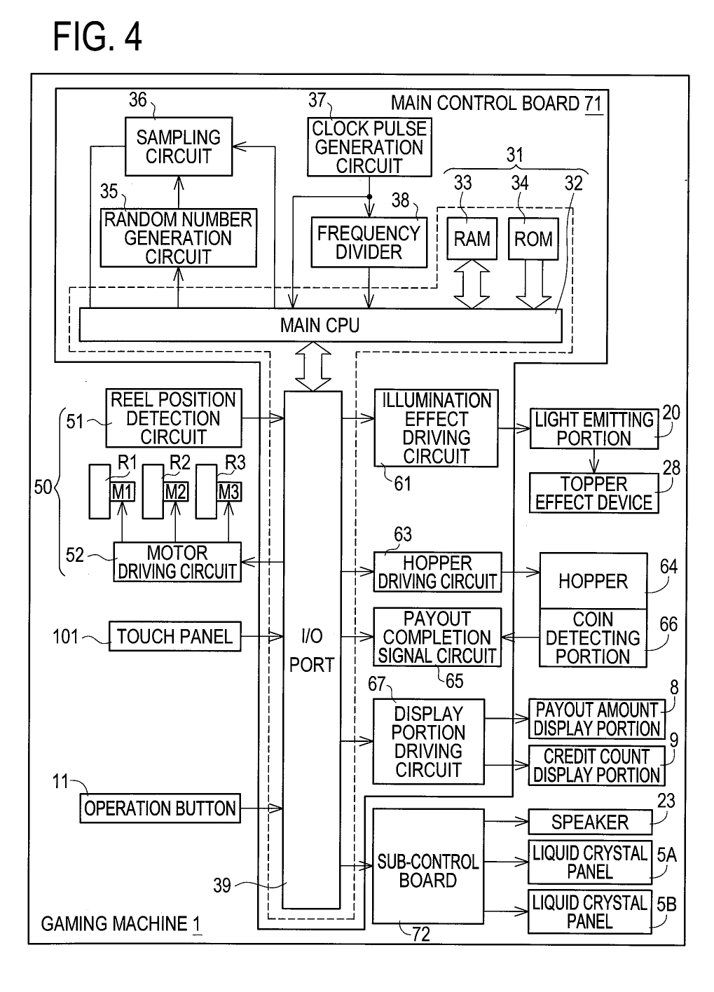

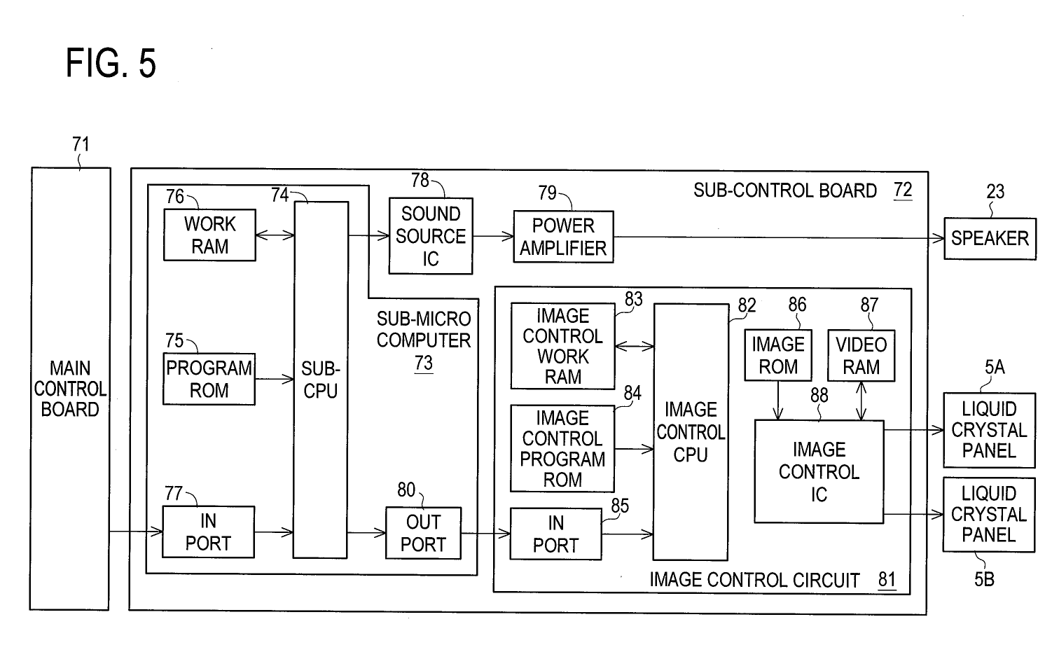

Next, the internal construction of the above gaming machine 1 will be explained with reference to FIG. 4 and FIG. 5.

FIG. 4 is a block diagram schematically showing the internal construction of entire gaming machine 1. As shown in FIG. 4, the gaming machine 1 includes a plurality of construction elements such as the main control board 71, in which a microcomputer 31 is included. The main control board 71 is constructed from a microcomputer 31, a random number generation device 35, a sampling circuit 36, a clock pulse generation circuit 37 and a frequency divider 38. The main control board 71 also includes an illumination effect driving circuit 61, a hopper driving circuit 63, a payout completion signal circuit 65 and a display portion driving circuit 67.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire gaming machine 1. Data and programs used when the main CPU 32 runs are stored in the RAM 33. For example, random numbers which are sampled by the after-mentioned sampling circuit 36 are stored temporarily after the start of the game, also the code No. of each reel R1, R2 and R3 and the symbol numbers are stored in the RAM 33. And the programs executed by the main CPU 32 and the permanent data are stored in the ROM 34.

Especially, the programs stored in the ROM 34 include the game programs and the game system programs (abbreviated as “the game programs and the like” hereinafter). And a lottery program mentioned below is also included in the game programs.

The lottery program is a program used to determine the code No. of each reel R1, R2 and R3 which corresponds to each symbol rearranged on the pay line L of the liquid crystal panel 5B. In the lottery program, it is included symbol weighing data corresponding to each of plural kinds of payout rates (for example, 80%, 84%, 88%). The symbol weighing data are the data indicating correlation between the code No. of each reel and one or plural random numbers belonging to a predetermined number range (0 to 255), every each of the three reels R1, R2 and R3.

In other words, each of the code No. of one reel is associated with one or more random numbers corresponding to the payout rate. The random number is extracted by the lottery program, and the symbol specified finally by the random number is rearranged on the pay line L of the liquid crystal panel 5B.

Random numbers over a predetermined range are generated by the random number generation device 35, which is operated based on the instructions from the main CPU 32. The random numbers are voluntarily extracted from the random numbers generated by the random number generation device 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38.

And to the main control board 71, a reel driving unit 50 is connected. The reel driving unit 50 includes a reel position detection circuit 51 which detects the positions of the three reels R1, R2 and R3, and a motor driving circuit 52 which inputs the driving signals to the motors M1, M2 and M3 which are used to rotate the reels R1, R2 and R3. The motors M1, M2 and M3 are operated based on the driving signals input from the motor driving circuit 52, and rotate the reels R1, R2 and R3, and stop the reels R1, R2 and R3 at a desired position.

Furthermore, the touch panel 101 is connected to the main control board 71. The touch panel 101 is arranged in front of the liquid crystal panel 5B, and specifies the coordinate position of the portion touched by the player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include a spin button, a collecting button and a BET button and the like. The signals corresponding to the pressing of these buttons are input to the main CPU 32 through I/O port 39.

The effect signals which are used to conduct illumination effect are output to the above-mentioned light emitting portion 20 and the topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65. The display operation of the payout amount display portion 8 and credit count display portion 9 is controlled by the display portion driving circuit 67.

Furthermore, a sub-control board 72 is connected to the main control board 71. As shown in FIG. 5, commands from the main control board 71 are input to the sub-control board 72. The display control on the liquid crystal panel 5A of the upper display portion 4A and the liquid crystal panel 5B of the variable display portion 4B, and the sound output control on a speaker 23 is executed by the sub-control board 72. The sub-control board 72 is constructed on a circuit board different from the circuit board for the main control board 71, and includes a microcomputer 73 (abbreviated as “sub-microcomputer” hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub-CPU 74, a program ROM 75, a work RAM 76, an IN port 77 and an OUT port 80. The control operations are executed by sub-CPU 74 based on the control order transmitted from the main control board 71, the program ROM 75 is used as a memory device. Although a clock pulse generation circuit, a frequency divider, a random number generation device and a sampling circuit are not included in the sub-control board 72, the sub-control board 72 is constructed so as to execute random number sampling according to the operation programs thereof. The control programs executed by the sub-CPU 74 is stored in the program ROM 75. The work RAM 76 is constructed as a temporary storing means when the above control programs are executed by the sub-CPU 74.

The image control circuit 81 includes an image control CPU 82, an image control work RAM 83, an image control program ROM 84, an image ROM 86, a video RAM 87 and an image control IC 88. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing means when the image control programs are executed by image control CPU 82. Images corresponding to the content determined by the image control CPU 82 are formed by the image control IC 88, and are output to the liquid crystal panel 5A, 5B.

In the image ROM 86, the dot data used to form images are stored. The video RAM 87 runs as a temporary storing means when the images are formed by the image control IC 88.

Next, winning combinations and the payout amounts corresponding to the winning combinations will be explained with reference to FIG. 6, wherein the winning combinations are the symbol combinations when the base game or the free game is executed by using each of the reels R1, R2 and R3 in the gaming machine 1 according to the embodiment. FIG. 6 is a payout table in which the winning combinations and the payout amounts corresponding to the winning combinations are shown when the base game or the free game is executed by using each of the reels R1, R2 and R3.

Here, the payout amount shown in FIG. 6 indicates the payout amount when the bet number is “1” in the base game. Therefore, when the bet number is “1”, the payout amount shown in FIG. 6 is paid out, and when the bet number is more than “2”, the payout amount obtained by multiplying the payout amount shown in FIG. 6 with the bet number is paid out.

On the other hand, the payout amount shown in FIG. 6 indicates the payout amount when the predetermined magnification is “1” in the free game. Therefore, in the free game, the payout amount obtained by multiplying the payout amount shown in FIG. 6 with the predetermined magnification is provided to the player.

Thereby, when three symbols of “FRANKENSTEIN” are rearranged on the pay line L of the liquid crystal panel 5B, the payout amount obtained by multiplying 10 credits with the bet number or the predetermined magnification is paid out. And in the base game, when the bonus trigger is realized, the free game is generated. Also, in the free game, the bonus trigger may be realized, at that time, a new free game is generated.

When three symbols of “Blue 7” are rearranged on the pay line L of the liquid crystal panel 5B, the payout amount obtained by multiplying 10 credits with the bet number or the predetermined magnification is paid out.

When three symbols of “BELL” are rearranged on the pay line L of the liquid crystal panel 5B, the payout amount obtained by multiplying 8 credits with the bet number or the predetermined magnification is paid out.

The payout amount corresponding to each winning combination shown in FIG. 6, are set as the same in the above. However, when a symbol combination constructed from the symbols rearranged on the pay line L of the liquid crystal panel 5B, is not any of the winning combinations shown in FIG. 6, the symbol combination is not a winning combination. Therefore, no credits may be paid out.

As mentioned above, in the gaming machine 1 according to the embodiment, the slot game is executed as the base game, and the free game is executed as the bonus game respectively.

In other words, in the base game, the slot game is executed by rearranging the symbol combination specified by each reel R1, R2 and R3 on the pay line L of the liquid crystal panel 5B. In the slot game, firstly, a part of symbol column (three symbols) displayed on the reel strip of each reel R1, R2 and R3 (shown in FIG. 3), is arranged on the liquid crystal panel 5B through each transparent display windows W1, W2 and W3 (see FIG. 7). Here, after a player sets the bet number by pressing the bet button among the operation buttons 11, if the player presses the spin button, each of the reels R1, R2 and R3 rotates, the symbol column displayed on the reel strip of each reel R1, R2 and R3 shown in FIG. 3, is scrolled from up to down on the liquid crystal panel 5B through each of the transparent display windows W1, W2 and W3 (see FIG. 8).

After a predetermined time, each reel R1, R2 and R3 stops automatically, a part of the symbol column (three symbols) displayed on the reel strip of each reel R1, R2 and R3 (shown in FIG. 3), is arranged on the liquid crystal panel 5B through each transparent display window W1, W2 and W3 (see FIG. 7). On the other hand, each winning combination based on each symbol combination is determined beforehand (see FIG. 6). When the symbol combination constructed from the three symbols rearranged on the pay line L of the liquid crystal panel 5B, realizes a winning combination, the payout amount obtained by multiplying the bet number with the payout amount corresponding to the realized winning combination is provided to the player.

On the other hand, in the free game as the bonus game, the slot game, in which a specific symbol combination is rearranged through each reel R1, R2 and R3 on the pay line L of the liquid crystal panel 5B, is repeated over a predetermined number of times. Also, in the slot game, a part of the symbol column (three symbols) displayed on the reel strip of each reel R1, R2 and R3 as shown in FIG. 3, is rearranged on the liquid crystal panel 5B through each transparent window W1, W2 and W3 (see FIG. 7). However, here, after a predetermined time, each reel R1, R2 and R3 rotates automatically. Thereby, no matter whether the player presses the operation buttons 11 such as the BET button or the spin button, the symbol column displayed on the reel strip of each reel R1, R2 and R3 as shown in FIG. 3, is scrolled from up to down and displayed on the liquid crystal panel 5B, through each transparent window W1, W2 and W3 (see FIG. 8).

Furthermore, after a predetermined time, each reel R1, R2 and R3 stops automatically, a part of the symbol column (three symbols) displayed on the reel strip of each reel R1, R2 and R3 as shown in FIG. 3, is rearranged on the liquid crystal panel 5B through each transparent window W1, W2 and W3 (see FIG. 7). On the other hand, similar to the above base game, each kind of winning combination is determined beforehand based on the symbol combination (see FIG. 6). When the symbol combination, which is constructed from the three symbols rearranged on the pay line L of the liquid crystal panel 5B, is a winning combination, the payout amount obtained by multiplying the payout amount corresponding to the realized winning combination with the predetermined magnification is provided to the player.

The predetermined magnification of the free game is determined in the selection game right after the game shifts to the free game, the determined magnification is displayed on the predetermined magnification display portion 211 on the liquid crystal panel 5B, as mentioned above.

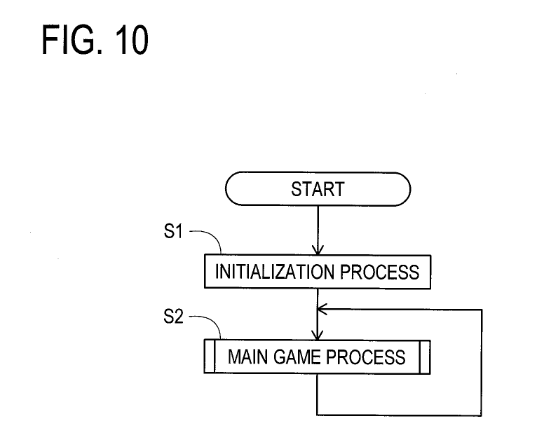

Next, the main control program executed in the gaming machine 1 according to the embodiment will be explained with reference to figures. FIG. 10 is a flowchart of the main control program.

First, when the power switch is pressed, the microcomputer 31 is started to operate, an initialization is executed by the microcomputer 31 in step (abbreviated as “S”) 1. In the initialization process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initialization process, the verification process to each program is executed.

And in S2, the main CPU 32 reads out the game programs and the like from the RAM 33, and executes the programs in sequence so as to conduct the main game process. The game is executed in the game machine 1 according to the embodiment by executing the main game process. And the main game process is repeated when the power is supplied to the game machine 1.

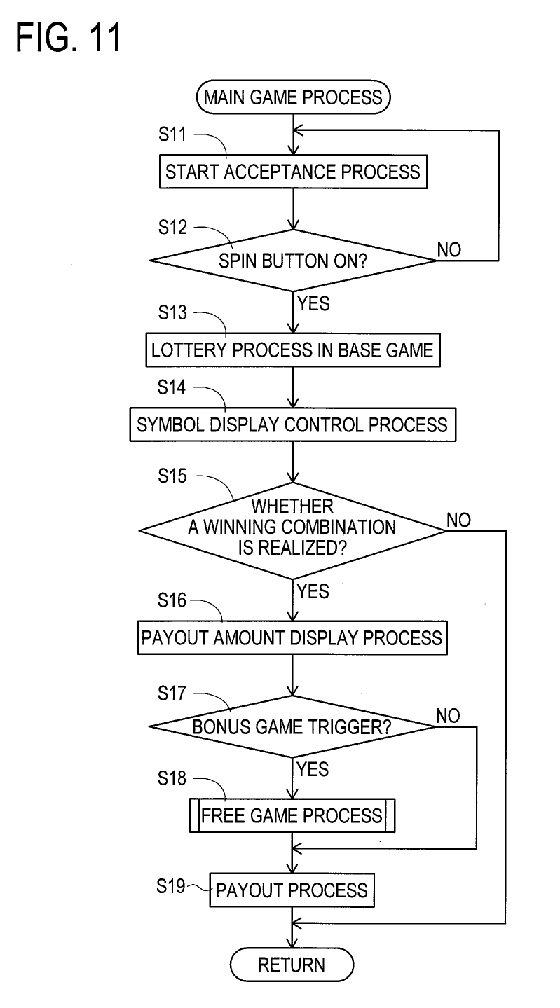

Next, the sub-process of the main game process in S2 will be explained with reference to FIG. 11. FIG. 11 is a flowchart of the main game process program in the game machine 1 according to the embodiment. Also, each program shown in the flowchart of FIG. 11 is stored in the ROM 34 or the RAM 33 of the game machine 1, and is executed by the main CPU 32.

First, as shown in FIG. 11, a start acceptance process is executed by the main CPU 32. At this time, in the start acceptance process, the insertion of the coins or the bet operation using the BET button among the operation buttons 11 is executed by the player. And the control signals are transmitted to the sub-control board 72 by the main CPU 32, so that each window W1, W2 and W3 of the liquid crystal panel 5B is shift/maintained in a transparent state.

And then, it is determined by the main CPU 32 whether the spin button among the operation buttons 11 is pressed in S13. It is determined based on the input signals corresponding to the button pressing of the operation button 11 to the main CPU 32. Here, when the spin button among the operation buttons 11 is not pressed (S12: NO), the game returns to the start acceptance process again. Thereby, it is possible to change the bet number and the like. On the other hand, when the spin button among the operation buttons 11 is pressed (S12: YES), the bet number set based on the above bet operation is reduced from the credits owned by the player at that time, and is stored in the RAM 33 as the bet information. And the credit count after reduction is also stored in the RAM 33 as the bet information.

In S13, a lottery process in the base game is executed by the main CPU 32. Concretely, when the lottery program included in the game programs is executed by the main CPU 32, the random number corresponding to each reel R1, R2 and R3 respectively is selected from a range of 0 to 255. And with reference to the symbol weighing data corresponding to the payout rate setting data, based on the three random numbers, the code No. of each reel R1, R2 and R3 is determined. The determined code No. of each reel R1, R2 and R3 is stored in the RAM 33 by the main CPU 32, and the game proceeds to S14.

Here, because the code No. of each reel R1, R2 and R3, corresponds to the symbol No. (symbol No. in FIG. 3) which is rearranged on the pay line L of the liquid crystal panel 5B, based on the determination of the code No. of each reel R1, R2 and R3 by the main CPU 32, the symbol combination in the game is determined. For example, when the code No. of each reel R1, R2 and R3 is determined as “21”, “21” and “21”, it is determined that the symbol combination is constructed from the three symbols of “FANKENSTEIN” by the main CPU 32 (see FIG. 3). Therefore, the lottery of the symbol combination in the base game is conducted based on the determination of the code No. of each reel R1, R2 and R3.

When the game proceeds to S14, the symbol display control process is executed by the main CPU 32. Concretely, first, the reel rotation process is executed by the main CPU 32. In other words, each motor M1, M2 and M3 is driven by the main CPU 32 through the motor driving circuit 52, so as to rotate each reel R1, R2 and R3. And then, the effect mode (the display mode of the images on the liquid crystal panel 5B and the sound output mode from the speaker 23) for each unit game is determined by the main CPU 32, and the sub-control board 72 is ordered to start the effect in a predetermined effect pattern. And then, when the predetermined stop timing to stop each reel R1, R2 and R3 comes, a reel stop process is executed by the main CPU 32 through the motor driving circuit 52, thereby each reel R1, R2 and R3 is stopped based on the code No. stored in the RAM 33. Thereby, the symbol combination determined in above S13 is rearranged on pay line L of the liquid crystal panel 5B.

And in the S15, it is determined by the main CPU 32 whether a winning combination is realized. The determination is made based on the code No. of each reel R1, R2 and R3 stored in the RAM 33. Here, when a winning combination is not realized (S15: NO), the program is executed again. On the other hand, when a winning combination is realized (S15: YES), the game proceeds to S16.

In S16, the payout amount display process is executed by the main CPU 32. Concretely, first, the payout amount obtained by multiplying the payout amount corresponding to the winning combination rearranged on the pay line L of the liquid crystal panel 5B with the bet number is calculated. And the calculation is executed based on the bet information in the RAM 33 and the payout table of FIG. 6, and the calculated amount is stored in RAM 33 as the payout information. And then, the control signals are transmitted to the display portion driving circuit 67 by the main CPU 32, the payout information stored in the RAM 33 (the above calculated amount) is displayed on the payout amount display portion 8 of the liquid crystal panel 5B.

And when the game proceeds to S17, it is determined whether a bonus game trigger is realized by the main CPU 32. Concretely, when the three symbols of “FANKENSTEIN” are rearranged on the pay line L of the liquid crystal panel 5B, it is determined that the bonus game trigger is realized. And this determination is executed based on the code No. of each reel R1, R2 and R3 stored in the RAM 33. Here, when a bonus game trigger is realized (S17: YES), the control signals are transmitted to the sub-control board 72 by the main CPU 32, each display window W1, W2 and W3 of the liquid crystal panel 5B is changed to an opaque state, and the title image of the free game is displayed on the liquid crystal panel 5B (see the right side of the first row in FIG. 1). And then in S18, the free game process is executed. Regarding the free game process, the detail will be explained later.

Next, in S19, the payout process is executed, including the case when the bonus game trigger is not realized (S17: NO). In the payout process, the payout amount obtained by the player in the base game and the free game, is paid out to the player respectively, based on the payout information stored in the RAM 33.

When the payout is executed, the credits which are stored in the RAM 33 as the payout information (the payout amount obtained by the player in the base game and the free game respectively) are added to the credits stored in the RAM 33 as the credit information, and the added value is overwritten in the RAM 33 as the credit information. And then, the control signals are transmitted to the display portion driving circuit 67 by the main CPU 32, the credits information stored in the RAM 33 (the added value in S19) is displayed on the credit display portion 9 of the liquid crystal panel 5B. At the same time, “0” is overwritten to the RAM 33 as the payout information, and by transmitting the control signals to the display portion driving circuit 67, on the payout amount display portion 8 of the liquid crystal panel 5B, “0” is displayed.

In the payout process, the credits owned by the player at that time (1 credit equals to 1 coin) may be paid out by the coins corresponding to based on the pressing on the CASHOUT button among the operation buttons 11, or may also be paid out by a ticket with a bar code which is printed by the ticket printer 14.

And the main game process is executed again after the payout process in above S19 is executed by the main CPU 32.

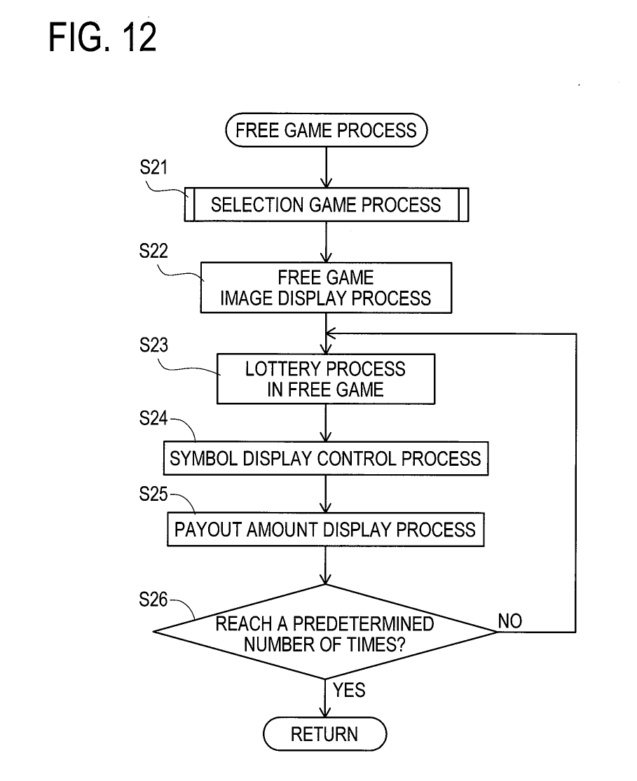

Next, the sub-process of the free game process in above S18 will be explained with reference to FIG. 12. FIG. 12 is a flowchart of a sub-process program of the free game in the gaming machine 1 according to the embodiment. The program shown in the flowchart of FIG. 12 is stored in the ROM 34 or the RAM 33 of the gaming machine 1, and is executed by the main CPU 32.

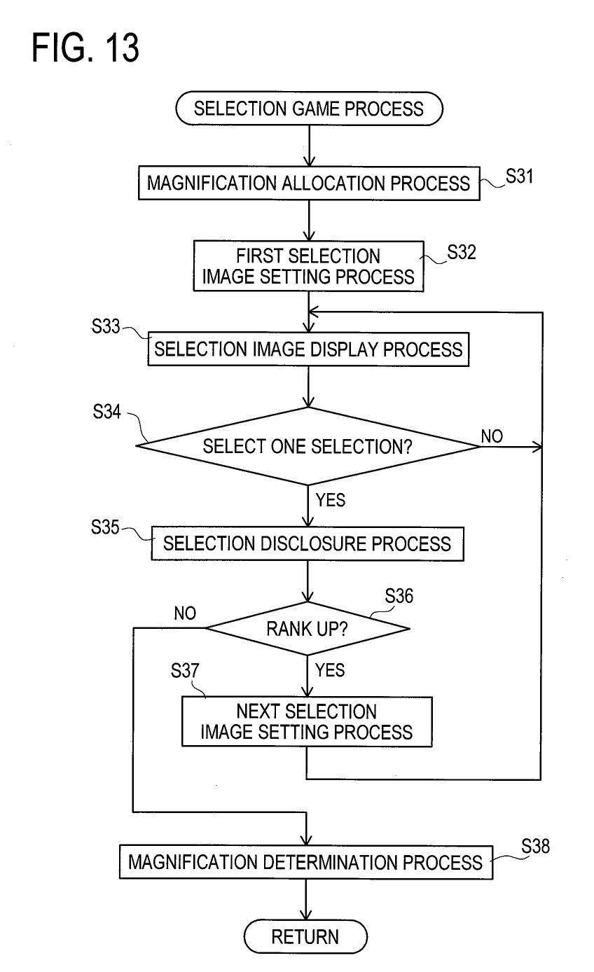

In the free game process of above S18, as shown in FIG. 12, firstly, the selection game is executed in S21 by the main CPU 32. Here, the sub-process of the selection game in above S21 is explained with reference to FIG. 13. FIG. 13 is a flowchart of a sub-process program of the selection game in the gaming machine 1 according to the embodiment. The program shown in the flowchart of FIG. 13 is stored in the ROM 34 or the RAM 33 of the gaming machine 1, and is executed by the main CPU 32.

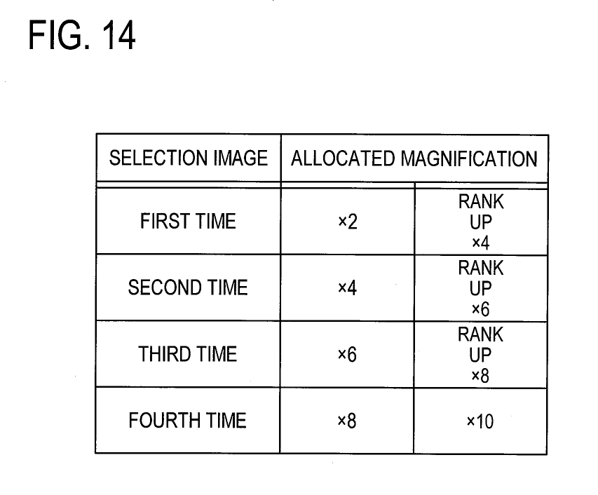

In the selection game process of above S21, as shown in FIG. 13, firstly, the magnification allocation process is executed in S31 by the main CPU 32. In the magnification allocation process, a predetermined magnification is allocated to each of the two selection buttons 201 on each of the first selection image to the fourth selection image. To explain it concretely, the predetermined magnification allocated to the two selection buttons 201 on the selection image, is different corresponding to the number of times of the selection image as shown in the table of FIG. 14. FIG. 14 is an explanatory view showing a correlation between a selection number of times of selection images and predetermined magnifications allocated to two selection buttons on the selection images.

As shown in FIG. 14, on the first selection image, to one of the selection buttons 201L and 201R, a predetermined magnification of “×2” is allocated. And to the other selection button of 201L and 201R, a predetermined magnification of “×4” and the message of “RANK UP” are allocated. On the second selection image, to one of the selection buttons 201L and 201R, a predetermined magnification of “×4” is allocated. And to the other selection button of 201L and 201R, a predetermined magnification of “×6” and the message of “RANK UP” are allocated. On the third selection image, to one of the selection buttons 201L and 201R, a predetermined magnification of “×6” is allocated. And to the other selection button of 201L and 201R, a predetermined magnification of “×8” and the message of “RANK UP” are allocated. On the fourth selection image, to one of the selection buttons 201L and 201R, a predetermined magnification of “×8” is allocated. And to the other selection button of 201L and 201R, a predetermined magnification of “×10” and the message of “RANK UP” are allocated.

In the magnification allocation process of S31, a random number is voluntarily selected from the random numbers over a predetermined range which are generated by the random number generation device 35. A predetermined magnification is allocated to one of the selection buttons 201L and 201R in a probability of ½ with reference to the allocation setting data, so that one predetermined magnification is allocated to the selection button 201L, and the other predetermined magnification is allocated to the selection button 201R. The magnification allocation process is executed in each of the first selection image to the fourth selection image. And the result of each magnification allocation process is stored in the RAM 33 as the allocation information. And the game proceeds to S32.

In S32, the setting process for the first selection image is executed by the main CPU 32. Concretely, the allocation result to the selection buttons 201L and 201R on the first selection image, is transmitted to the sub-control board 72 by the main CPU 32. And the game proceeds to S33.

In S33, the selection image setting process is executed by the main CPU 32. Concretely, based on the transmission of the control signals to the sub-control board 72 by the main CPU 32, selection images shown on the middle column in FIG. 9 are displayed on the liquid crystal panel 5B. And then the game proceeds to S34.

In S34, it is determined by the main CPU 32 whether one of the selections is selected by the player. Based on the coordinate position information from the touch panel 101, when the coordinate position information indicating the area of the touch panel 101 corresponding to any of selection button 201L or 201R is input, it is determined that one of the selections is selected by the player. Here, when any selection is not selected by the player (S34: NO), the game returns to S33. On the other hand, one of the selections is selected by the player (S34: YES), the game proceeds to S35.

In S35, the selection disclosure process is executed by the main CPU 32. Concretely, the control signals are transmitted to the sub-control board 72 by the main CPU 32, based on the magnification allocation result newly transmitted to the sub-control board 72 in above S32 or in below S37, the magnification allocation result to each of the selection buttons 201L or 201R, is displayed on the selection image shown in the current liquid crystal panel 5B. In this process, as shown in the selection images on the liquid crystal panel 5B displayed on the both sides of each row in FIG. 9, the two selection buttons 201L and 201R are opened, and the mathematical formula of the predetermined magnification allocated to each selection button respectively is displayed. Here, the predetermined magnification allocated to the selected button 201 is more clearly shown than that of the predetermined magnification allocated to the not selected button 201. And then the game proceeds to S36.

In S36, it is determined whether there exists a rank up of the magnification by the main CPU 32. This determination is made based on the coordinate position information from the touch panel 101 and the allocation information stored in the RAM 33 in above S31. When the message of “RANK UP” is added on the predetermined magnification allocated to the selected button 201, it is determined that there exists a rank up of the magnification.

Here, when there exists a rank up (S36: YES), the game proceeds to S37. In S37, the setting process for the next selection image is executed by the main CPU 32. Concretely, when the first selection image is displayed in the current liquid crystal panel 5B, the allocation result to the selection buttons 201L and 201R on the second selection image is transmitted to the sub-control board 72 by the main CPU 32. When the second selection image is displayed in the current liquid crystal panel 5B, the allocation result to the selection buttons 201L and 201R on the third selection image is transmitted to the sub-control board 72 by the main CPU 32. And when the third selection image is displayed in the current liquid crystal panel 5B, the allocation result to the selection buttons 201L and 201R on the fourth selection image is transmitted to the sub-control board 72 by the main CPU 32. Then the game returns to S33.

On the other hand, when there does not exist a rank up of the magnification (S36: NO), the game proceeds to S38. In S38, based on the allocation result to the selection buttons 201L and 201R on the current selection image displayed in the current liquid crystal panel 5B, the predetermined magnification allocated to the selected button 201, is determined as the predetermined magnification for the free game. And the determined magnification is stored in the RAM 33 as predetermined magnification information. And then the game returns to the free game process shown in FIG. 12.

When the game proceeds to S22, the free game image display process is executed. Concretely, the control signals are transmitted to the sub-control board 72 by the main CPU 32, the liquid crystal panel 5B is returned to the display state just before the game shifts to the free game (as shown on the right side of the fourth row in FIG. 1). In other words, on the liquid crystal panel 5B, the pay line L is displayed again. The three display windows W1, W2 and W3 are turned to transparent, and each reel R1, R2 and R3 is visible by the player again. Furthermore, on the liquid crystal panel 5B, the predetermined magnification display portion 211, which shows the number of the predetermined magnification determined in above S38, is newly displayed (see the both sides of the fourth row in FIG. 1).

In S23, the lottery process for the free game is executed by the main CPU 32. Concretely, the lottery program included in the game programs is executed, a random number corresponding to each reel R1, R2 and R3 is selected respectively from the range of 0 to 255. And with reference to the symbol weighing data corresponding to the payout rate setting data, based on the three selected random numbers, the code NO. of each reel R1, R2 and R3 is determined. And the determined code NO. of each reel R1, R2 and R3 is stored in the RAM 33, and the game proceeds to S24.

Here, because the code NO. of each reel R1, R2 and R3 is corresponded to the symbol No. (symbol No. in FIG. 3) which is rearranged on the pay line L of the liquid crystal panel 5B, based on the determination of the code No. of each reel R1, R2 and R3 by the main CPU 32, the symbol combination in the game is determined. For example, when the code No. of each reel R1, R2 and R3 is determined as “13”, “08” and “07”, it is determined that the symbol combination is constructed from the three symbols of “Blue 7” by the main CPU 32 (see FIG. 3). The lottery of the symbol combination in the free game is conducted based on the determination of the code No. of each reel R1, R2 and R3.

When the game proceeds to S24, the symbol display control process is executed by the main CPU 32. Concretely, first, the reel rotation process is executed by the main CPU 32. In other words, each motor M1, M2 and M3 is driven by the main CPU 32 through the motor driving circuit 52, so as to rotate each reel R1, R2 and R3. And then, the effect mode (the display mode of the images on the liquid crystal panel 5B and the sound output mode from the speaker 23) for each unit game is determined by the main CPU 32, and the sub-control board 72 is ordered to start the effect in a predetermined effect pattern. And then, when the predetermined stop timing to stop each reel R1, R2 and R3 comes, a reel stop process is executed by the main CPU 32, through the motor driving circuit 52, each reel R1, R2 and R3 is stopped based on the code No. stored in the RAM 33. Thereby, the symbol combination determined in above S23 is rearranged on pay line L of the liquid crystal panel 5B.

In S25, the payout amount display process is executed by the main CPU 32. Concretely, first, the payout amount obtained by multiplying the payout amount corresponding to the winning combination rearranged on the pay line L of the liquid crystal panel 5B with the predetermined magnification (the number shown on the predetermined magnification display portion 211) is calculated. And the calculation is executed based on the predetermined magnification information stored in the RAM 33 and the payout table of FIG. 6, and the calculated amount is stored in RAM 33 as the payout information. And then, the control signals are transmitted to the display portion driving circuit 67 by the main CPU 32, the payout information stored in the RAM 33 (the above calculated amount) is displayed on the payout amount display portion 8 of the liquid crystal panel 5B.

And when the game proceeds to S26, it is determined whether the unit game is repeated over a predetermined number of times. Concretely, a variable saved in the RAM 33 beforehand is changed to “0” when the game shifts to the free game, and the variable is incremented every time the process of S29 is executed, and then the variable is compared with a predetermined number of times. And the predetermined number of times becomes a number of times which is set beforehand (for example, 20 times). Here, when the unit game is not repeated over a predetermined number of times (S26: NO), the game returns to the lottery process in the free game (S23) again. Thereby, the next unit game is executed. On the other hand, when the unit game is repeated over a predetermined number of times (S26: YES), the free game is terminated, and the game returns to the main game process shown in FIG. 11.

As explained above, in the free game executed in the gaming machine 1 according to the embodiment, the unit game is constructed from a series of processes (S23 to S25), including the symbol display process (S24) in which the symbols are started to be variably displayed until the symbols are stopped to be displayed through each display window W1, W2 and W3 of the liquid crystal panel 5B. And the unit game is repeated until the number of times of the game reaches a predetermined number of times (S26), the payout amount is increased based on the execution result (S25).

Also, when the game shifts from the base game to the free game, before the first unit game of the free game is executed, the selection game process (S21) to determine the predetermined magnification of the free game is executed, and the predetermined magnifications with the two different number are allocated to the two selection button 201L, 201R respectively (S31).

The selection image in which the two selection buttons are arranged (see the each row of the middle column in FIG. 9) is displayed on the liquid crystal panel 5B (S33), and the predetermined magnification is determined based on the selection result that any of the two selection buttons 201L and 201R is selected by the player on (S38). Then, the unit game with the predetermined magnification is executed over the predetermined number of times (S22 to S26), therefore, the feeling of tension for the player to determine the predetermined magnification which increases the payout amount by himself/herself in the selection game can be upgraded.

Here, the predetermined magnification which increases the payout amount is determined based on the selection of the player, and the payout rate is not likely to fluctuate. Therefore, it is easy to adjust the payout rate by setting the determination range of the predetermined magnification in the selection game in a large or narrow range beforehand.

For example, in the embodiment, the predetermined magnifications in the selection game are determined as one of the “×2”, “×4”, “×6”, “×8” and “×10”. Thereby, when the payout rate increases too much, the predetermined magnification in the selection game may be narrowed down to “×2”, “×4” and “×6”, and when the payout rate decreases too much, the predetermined magnification in the selection game may be returned back to “×2”, “×4”, “×6”, “×8” and “×10”. Or when the payout rate increases too much, the predetermined magnification in the selection game may be replaced with “×1”, “×3”, “×5”, “×7” and “×9”, and when the payout rate decreases too much, the predetermined magnification in the selection game may be returned back to “×2”, “×4”, “×6”, “×8” and “10”.

In the selection game to determine the predetermined magnifications, on the first selection image to the third selection image, when the selection button 201 corresponding to the predetermined magnification with a smaller value is selected by the player (S36: NO), the predetermined magnification corresponding to the selection button 201 is determined as the predetermined magnification for the free game (S38), thereby, regarding the feeling of tension of a player, a kind of thrilling feeling may be provided to the player by determining the predetermined magnification with a smaller value.

On the other hand, on the first selection image to the third selection image, when the selection button 201 corresponding to the predetermined magnification with a larger value is selected by the player (S36: YES), the next selection image, on which two new different predetermined magnifications corresponding to the two selection buttons 201L and 201R are displayed, is displayed with values larger than this value (S37), thereby, the selection game is executed continuously. Therefore, regarding the feeling of tension, a feeling of more tension to continue the selection game in which the player may select a furthermore larger number as the predetermined magnification, may be provided to the player.

Furthermore, since a limit is set beforehand on the number of times to continuously execute the selection game, on the fourth selection image, even when the selection button 201 corresponding to the predetermined magnification with a larger value is selected by the player, the predetermined magnification corresponding to the selection button 201 is determined as the predetermined magnification for the free game (see the both sides of the fourth row in FIG. 9). Therefore, in this case, even when the predetermined magnification which may increase the payout amount is determined based on the player's selection, the upper limit number of times of the determination range of the predetermined magnification in the selection game is already determined in advance (in the embodiment is “×10”), thus the increase of the payout rate may be controlled easily.

Here, the gaming machine is not limited to the above embodiment.

For example, in the free game, when the rearrangement of the winning combination is realized on the pay line L of the liquid crystal panel 5B, the calculation formula may be temporarily displayed along with the payout amount, which is obtained by multiplying the payout amount corresponding to the winning combination with the predetermined magnification determined in the selection game.

Also, in the selection game, the magnitude relation is used as the base of determining the predetermined magnification and developing to next selection image, however, the relation in the magnitude may be reversed. In other words, on the first to the third selection images, when the selection button 201 corresponding to the predetermined magnification with a smaller value is selected by the player, the next selection image corresponding to the two new different predetermined magnifications associated with the two selection buttons 201L and 201R, is displayed, and the selection game is executed continuously. On the other hand, when the selection button 201 corresponding to the predetermined magnification with a larger value is selected by the player, the predetermined magnification corresponding to the selection button 201 is determined as the predetermined magnification of the free game.

In the gaming machine according to the embodiment, the slot machine with three mechanical reels is used, a slot machine with five reels or with nine reels may also be used in the slot machine. Also, a slot machine with video reels may also be used.

In the gaming machine according to the embodiment, there is one pay line L, however, a plurality of pay lines L may be used in the embodiment. In this case, in the base game (slot game), the number of the activated pay line L is usually set along with the bet number among all the pay lines L. However, the bet number may also be set after the setting of the number of the activated pay line L, or the number of the activated pay line L may also be set after the setting of the bet number.

The concept may also be applied to the techniques determining the attribution items of the bonus game in the gaming machine.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display device for displaying a plurality of symbols thereon; and
a processor for controlling the display device;
wherein the processor is programmed to
(a) execute a bonus game in which a unit game is executed over a predetermined number of times, the unit game being conducted on the display device after the symbols are started to be variably displayed until the symbols are stopped, and a payout is increased with a predetermined magnification based on a game result of the unit games,
(b) execute a selection game to determine the predetermined magnification before the unit game is executed by displaying on the display device a selection image having two selections each of which is corresponded to each of two magnifications with a first value and a second value larger than the first value respectively and determining the predetermined magnification corresponding to a selection result that any one of the magnifications is selected, and
(c) terminate the bonus game by executing the unit games over the predetermined number of times with the predetermined magnification.

2. The gaming machine according to claim 1, wherein when the selection corresponded to the first value smaller than the second value is selected, the processor determines the magnification corresponding to the selection with the first value as the predetermined magnification.

3. The gaming machine according to claim 1, wherein when the selection corresponded to the second value larger than the first value is selected, the processor continuously again executes the selection game on the display device by newly corresponding two magnifications with a third value and a forth value larger than the third value, both of the third and fourth values being larger than both of the first and second values, to the two selections.

4. The gaming machine according to claim 3, wherein the processor is programmed to
(d) provide in advance a limit number of times for a number of times of the selection game according to which the selection game is continuously again executed, and
(e) determine beforehand the magnification corresponding to the selection as the predetermined magnification when the selection game with the limit number of times is executed and the selection with the forth value larger than the third value is selected.

5. A gaming machine comprising:
a display device for displaying a plurality of symbols thereon; and
a processor for controlling the display device;
wherein the processor is programmed to
(a) execute a bonus game in which a unit game is executed over a predetermined number of times, the unit game being conducted on the display device after the symbols are started to be variably displayed until the symbols are stopped, and a payout is increased with a predetermined magnification based on a game result of the unit games,
(b) execute a selection game to determine the predetermined magnification before the unit game is executed by displaying on the display device a selection image having two selections each of which is corresponded to each of two magnifications with a first value and a second value larger than the first value respectively and determining the predetermined magnification corresponding to a selection result that any one of the magnifications is selected, and
(c) determine the magnification corresponding to the selection with the first value as the predetermined magnification when the selection corresponded to the first value smaller than the second value is selected,
(d) continuously again execute the selection game on the display device by newly corresponding two magnifications with a third value and a forth value larger than the third value, both of the third and fourth values being larger than both of the first and second values, to the two selections, when the selection corresponded to the second value larger than the first value is selected,
(e) provide in advance a limit number of times for a number of times of the selection game according to which the selection game is continuously again executed, and
(f) determine beforehand the magnification corresponding to the selection as the predetermined magnification when the selection game with the limit number of times is executed and the selection with the forth value larger than the third value is selected, and
(g) terminate the bonus game by executing the unit games over the predetermined number of times with the predetermined magnification.
